(19) United States
(12) Patent Application Publication
(10) Pub. No.: US 2007/0125863 A1
(43) Pub. Date: Jun. 7, 2007

(54) System and method for employing infrared illumination for machine vision

(76) Inventors: Timothy A. Jakoboski, Lake Oswego, OR (US); Brian Looney, Tualatin, OR (US)

Correspondence Address: COGNEX CORPORATION;INTELLECTUAL PROPERTY DEPARTMENT, 1 VISION DRIVE, NATICK, MA, 01760-2077, US

(21) Appl. No.: 11/293,979

(22) Filed: Dec. 5, 2005

(51) Int. Cl. G06K 7/10

(52) U.S. Cl. 235/462.41; 235/462.42

(57) ABSTRACT

This invention provides a machine vision device adapted to read inscribed symbology on the surface of an object, such as a wafer, covered in photoresist that employs both bright field and dark field illumination in the infrared region. Using illumination with light in this spectral band, an inscribed symbol can be read by a camera sensor substantially unaffected by the presence of and/or number of layers of photoresist covering the symbol. The camera sensor is tuned to receive such illumination, and is thereby provided with an image that distinguishes the symbol's scribe lines on the underlying wafer surface from the surrounding specular wafer surface. The device includes a housing that supports the imager and imager lens below an array of IR LEDs. The sensor has an optical axis that is reflected from horizontal to vertical by a mirror and then back to horizontal by a beam splitter that is aligned with two spherical lenses and an outlet window at the front of the housing. The array is located in line with lenticular arrays behind the beam splitter, along the central optical axis of the lenses and window.

### BACKGROUND OF THE INVENTION

1. Field of the Invention

This invention relates to machine vision systems and more particular to machine vision systems employed to read symbology located on substrates covered with a photoresist material.

2. Background Information

Machine vision systems use image acquisition devices that include camera sensors to deliver information on a viewed subject. The system then interprets this information according to a variety of algorithms to perform a programmed decision-making and/or identification function. For an image to be most-effectively acquired by a sensor in the visible, and near-visible light range, the subject should be properly illuminated.

In the example of symbology reading (also commonly termed “barcode” scanning) using an image sensor, proper illumination is highly desirable. Symbology reading entails the aiming of an image acquisition sensor (CMOS camera, CCD, etc.) at a location on an object that contains a symbol (a “barcode”), and acquiring an image of that symbol. The symbol contains a set of predetermined patterns that represent an ordered group of characters or shapes from which an attached data processor (for example, a microcomputer) can derive useful information about the object (e.g. its serial number, type, model price, etc.). Symbols/barcodes are available in a variety of shapes and sizes. Two of the most commonly employed symbol types used in marking and identifying objects are the so-called one-dimensional barcode, consisting of a line of vertical stripes of varying width and spacing, and the so-called two-dimensional barcode consisting of a two-dimensional array of dots or rectangles.

One application in which machine vision is employed is in the identification of silicon wafers used in the production of electronic integrated circuits. As wafers are moved through various stages of the (increasingly complex) fabrication process, they are tracked for a variety of reasons. In the highly automated environment of a fabrication plant tracking is a non-human task, handled by machine vision devices deployed at different locations around the production line to capture images of the wafers as they pass an inspection point. The machine vision devices are adapted to identify symbology on the wafer such as a barcode and/or alphanumeric code. The code is placed at a convenient location of the wafer surface, typically near an edge. The code is generally etched into the otherwise specular (reflective) surface of the wafer.

By way of background FIG. 1 shows an exemplary scanning system 100 adapted for inspecting symbology (two-dimensional barcode symbol 102) on a wafer 103. An exemplary machine vision device 104 (shown in cutaway to reveal basic internal components) is provided to read and identify the barcode 102. An image formation system 150 can be controlled and can direct image data to an onboard embedded processor 109. In this example, the image is transmitted from the field of view 130 around the symbol/barcode 102 through a window 132 to a mirror 134. The mirror redirects the image light into the lens 140 of the image formation system 150. The processor 109 can include a scanning software application 113 by which illumination of the field of view 130 (via illuminator 160) is controlled, images are acquired and image data is interpreted into usable information (for example, alphanumeric strings derived from the symbol 102. The decoded information can be directed via a cable 111 to a PC or other data storage device 112 having (for example) a display 114, keyboard 116 and mouse 118, where it can be stored and further manipulated using an appropriate application 121. Alternatively, the cable 111 can be directly connected to an interface in the scanning appliance and an appropriate interface in the computer 112. In this case the computer-based application 121 performs various image-interpretation/decoding and illumination control functions as needed. The precise arrangement of the machine vision device 104 with respect to an embedded processor, computer or other processor is highly variable. For example, a wireless interconnect can be provided in which no cable 111 is present. Likewise, the depicted microcomputer can be substituted with another processing device, including an onboard processor or a miniaturized processing unit such as a personal digital assistant or other small-scale computing device.

Referring briefly to FIG. 1A the arrangement of a typical etched or scribed symbol 170 on a wafer is shown. This symbol is surrounded by a viewed rectangular area of interest 172 that appears dark in this diagram due to the use of dark field illumination. Conversely the symbol scribes appear as brighter features. The symbol 170 in this example consists of two portions, an alphanumeric code 174 and a two-dimensional barcode 176. A variety of types of codes and/or combinations of different code types can be provided in various examples.

As shown in FIG. 1B, the same symbol 180 herein is acquired using bright field illumination. The symbol 180 is generally surrounded by a bright viewing area 182 from reflected light in which the scribe lines of the alphanumeric code 184 and barcode 186 appear dark due to refracted light that does not reach the imager.

The reading of etched or scribed symbology on a wafer can be highly problematic. This is because, at various production stages, the wafer is coated with one or more layers of photoresist. Photoresist is a well-known group of chemical substances (silicon nitride, for example) that react to light of a certain type or wavelength range (UV-light, for example) to undergo a chemical change. In the production of circuits, the change allows the exposed areas of the photoresist to become susceptible to attack by acid or caustic gas (an etching agent). Thus, the areas of exposed photoresist selectively allow the etching agent to reach the underlying substrate, while unexposed areas resist attack by the agent. This selectivity, thus allows formation of traces and circuit elements on the etched regions using deposition and other techniques. A large number of layers may be applied to a wafer, each being approximately 1500 Angstroms thick.

The symbol may or may not be covered by photoresist. This is, in part, because wafers are clamped at various locations about their perimeters during various stages of photoresist layer-application. The clamped areas are masked against layer application. Clamps do not always contact particular parts of the wafer during layer application. Thus, it is possible for the continued placement of the clamps of a number of steps to create a pattern of coverage over a symbol that is several layers thick in some places and devoid of layers in other places.

Referring to FIG. 2, a schematic representation of the general effect of photoresist layers on the reading of a symbol by the machine vision device is shown. In this example, the light (rays 210, 212, 214 and 216) is derived from a bank of conventional red light emitting diodes (LEDs). The machine vision device (camera) 220 is shown in front view. It projects red (or another visible color or colors) light from an illuminator (not shown) onto and area of interest 230 of the photoresist-covered wafer. The area of interest includes the scribe marks 232 and 234 that are part of a symbol. Fortuitously, some of the scribe lines (234) are exposed, without resist on the wafer surface 240. Other scribe lines (232) are covered by one or two layers 250 and 252 of photoresist.

In an ideal situation, the specular surface of the wafer reflects the illuminator's high-angle (bright field) illumination (as shown by the rays 210, 212, 214 and 216) back to the camera 220, thereby generating an overall bright background. This is best exemplified by the ray 214, which directly strikes the uncovered wafer surface 240 and is reflected largely back as reflected ray 264. The bright areas are surrounded by discernable dark spots where the light (exemplary ray 216) enters a scribe (234), and is scattered and/or reflected away (rays 266) from the camera. However, where one or more layers of photoresist are present (for example layers 250 and 252) the rays 210 and 212 become significantly attenuated and bent as shown. Notably, the wafer surface is highly specular, while the photoresist is more translucent. In reaching the underlying wafer surface, the resulting reflected light (ray 270) must also pass through one or more layers (in this example, the bottom layer 252), and is therefore refracted further than the reflected ray 264. In practice this may cause reflected light to appear as a “rainbow” of colors. This effect significantly varies the contrast between the adjacent surface 280 and the covered scribe 232 (especially where monochromatic LED illumination is employed), thereby rendering the device less reliable. In addition, as shown, the degree of photoresist layering may vary across a symbol. In general, the acquired image of a typical wafer symbol under red LED illumination appears as a bright background with dark scribe marks in unlayered areas and overall dark in layered areas. It would seem that adjusting the device contrast settings might help alleviate the problem. However, since the degree of contrast between background and scribes can vary greatly across the symbol. Thus, a simple increase in overall device contrast settings will result mainly in a washout of bright areas while making the dark background areas only somewhat more-discernable from adjacent scribes.

By way of further background, a description of the effects of reflected light transmission through layers of silicon nitride can be found in the report entitled Improvement to Reflective Dielectric Film Color Pictures, by Joshua Kvavie, et al., published 15 Nov. 2004, Vol. 12, No. 23 Optics Express (pages 5789-5794), the teachings of which are expressly incorporated herein by reference.

Note that the illumination of the variably layered/non-layered wafer surface 240 with low-angle (dark field) illumination generates somewhat similar, undesirable effects as those described above for bright field illumination. Referring to FIG. 2A, dark field illumination is directed at each portion of the variously layered surface. Rays 280 and 282 pass through the layers 250 and 252. Ray 280 eventually strikes the surface 240 and is reflected as low-angle ray 284, missing the camera 220. These rays produce the generally dark background shown in FIG. 1A. The ray 282, conversely strikes the scribe 232 and is at least partially refracted into the camera 220 as ray 286. This line is shown as a dashed line as the effect of the layers is to significantly attenuate the visible light in ray 286. This makes for rather low contrast in layered regions. Likewise, in unlayered regions the dark field illumination from rays 290 and 292 is either reflected away by the surface (ray 294) or refracted from within the scribe 234 into the camera 220 as ray 296. Ray 296 is generally stronger than ray 286 leading to some of the above-described contrast problems.

One technique for “seeing through” layering is to employ shorter-wavelength blue visible light. However, this solution still experiences some of the effects of contrast variation across a variably layered area of interest. More significantly, many circuit fabrication processes specifically forbid the use of blue light in inspection because of the risk of inadvertent photoresist exposure. Accordingly, another solution to reading symbology through one or more, possibly varying layers of photoresist is highly desirable.

### SUMMARY OF THE INVENTION

This invention overcomes the disadvantages of the prior art by providing a machine vision device adapted to read inscribed symbology on the surface of an object, such as a wafer, covered in photoresist that employs both bright field and dark field illumination in the infrared region. Using illumination with light in this spectral band, an inscribed symbol can be read by a camera sensor substantially unaffected by the presence of and/or number of layers of photoresist covering the symbol. The camera sensor is tuned to receive such illumination, and is thereby provided with an image that distinguishes the symbol's scribe lines on the underlying wafer surface from the surrounding specular wafer surface.

In an illustrative embodiment, the machine vision device includes a housing that supports the imager and imager lens below an array of IR LEDs. The sensor has an optical axis that is reflected from horizontal to vertical by a mirror and then back to horizontal by a beam splitter that is aligned with two spherical lenses and an outlet window at the front of the housing. The array is located in line behind the beam splitter, along the central optical axis of the spherical lenses and window so as to direct illumination through the beam splitter and out the window. A pair of lenticular arrays is provided between the array and the beam splitter to spread the light from individual LEDs into a substantially continuous line. The array is adapted to provide lines of illumination from each of two adjacent horizontal rows of LEDs. The pairs of rows are individually addressed to generate varying degrees of low-angle dark field illumination and high-angle bright field illumination. The rows are optically isolated from each other using, for example a conformal coating that is injected so as to surround individual LEDs and thereby prevent light from migrating through side edges into adjacent rows. Typically rows on each vertical edge generate the maximum degree of low-angle light, while the central rows generate the most axially aligned high-angle, bright field light. A tuning procedure allows rows to be addressed according to a predetermined pattern to derive a readable or best acquired image of the surface.

### BRIEF DESCRIPTION OF THE DRAWINGS

The invention description below refers to the accompanying drawings, of which:

FIG. 1, already described, is a somewhat schematic diagram of a prior implementation of a machine vision system employed for wafer symbology inspection;

FIG. 1A, already described, is a more detailed view of a typical etched or scribed symbol provided to a semiconductor wafer as acquired using dark field illumination;

FIG. 1B, already described, is a more detailed view of a typical etched or scribed symbol provided to a semiconductor wafer as acquired using bright field illumination

FIG. 2, already described, is a schematic cross section of the effects of illuminating an area on a wafer containing an etched or scribed symbol using conventional bright field visible light;

FIG. 2A, already described, is a schematic cross section of the effects of illuminating an area on a wafer containing an etched or scribed symbol using conventional dark field visible light;

FIG. 3 is an exposed perspective view of a machine vision device having an IR illumination assembly according to an illustrative embodiment of this invention;

FIG. 4 is a side cross section of the machine vision device of FIG. 3 detailing the optical path of the imager and illumination assembly;

FIG. 5 is a plan view of the illumination assembly, detailing individual IR light emitting diodes (LEDs) arranged in an array of horizontal rows and vertical columns

FIG. 6 is a schematic diagram of a portion of the array of FIG. 5;

FIG. 6A is a fragmentary perspective view of a plurality of LEDs in the illumination assembly detailing a conformal coating that optically isolates adjacent side edges; and

FIG. 7 is a flow diagram of a general procedure for tuning the illumination of the machine vision device to obtain the best image.

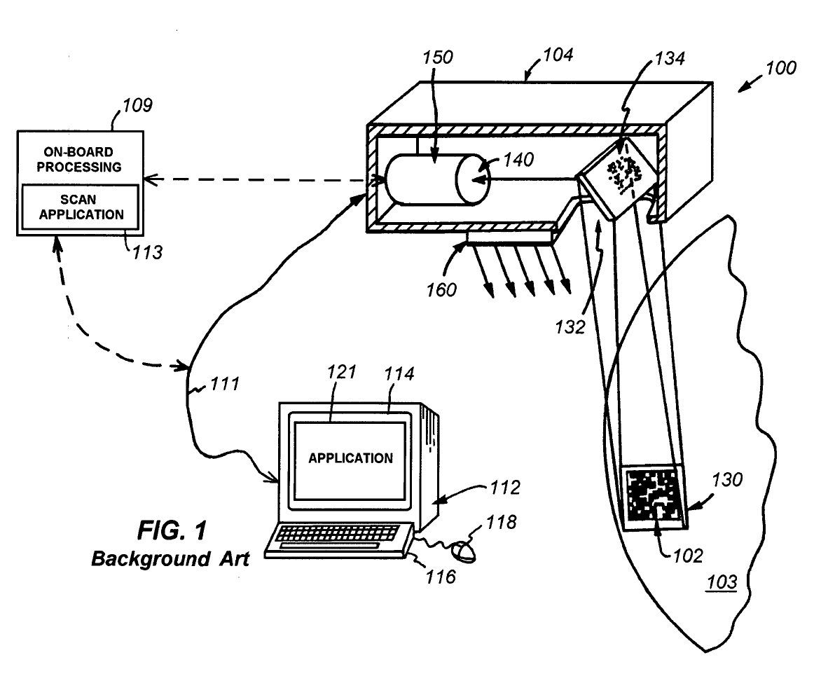

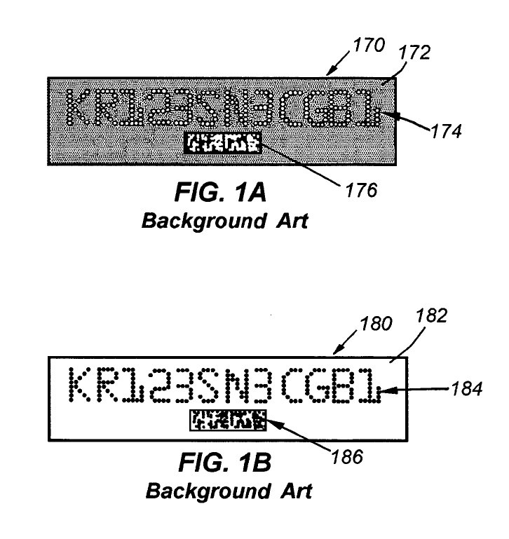

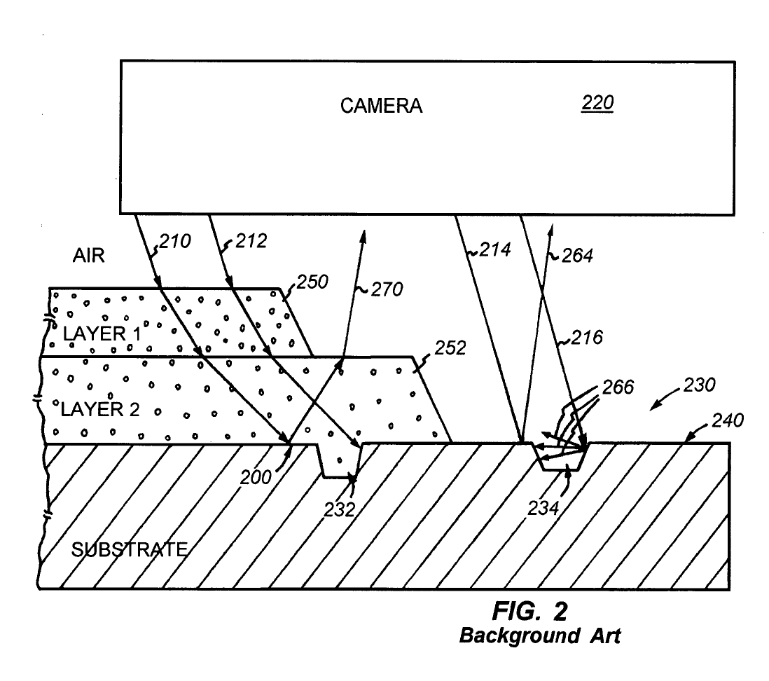

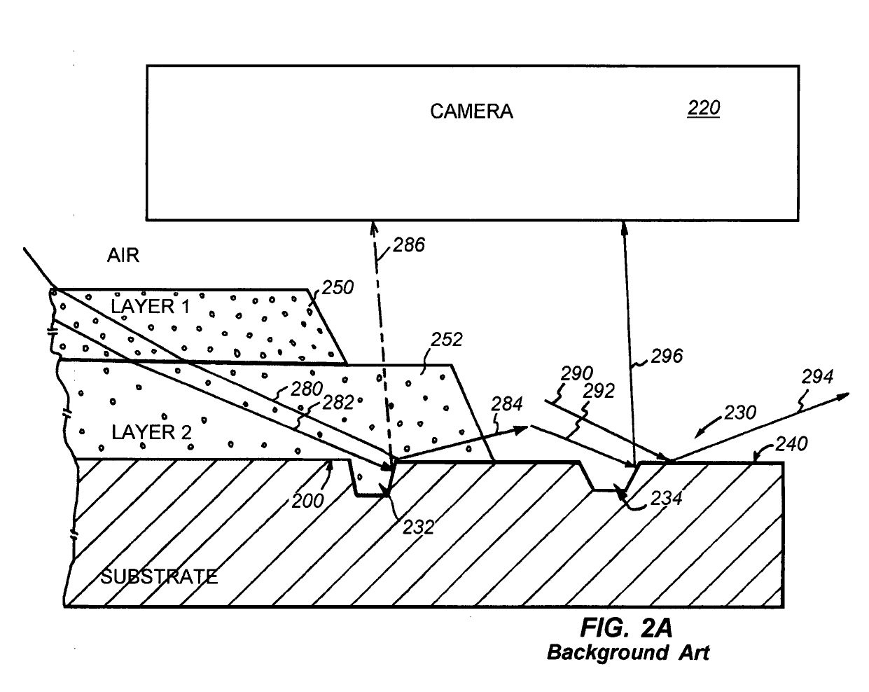

### DETAILED DESCRIPTION OF AN ILLUSTRATIVE EMBODIMENT

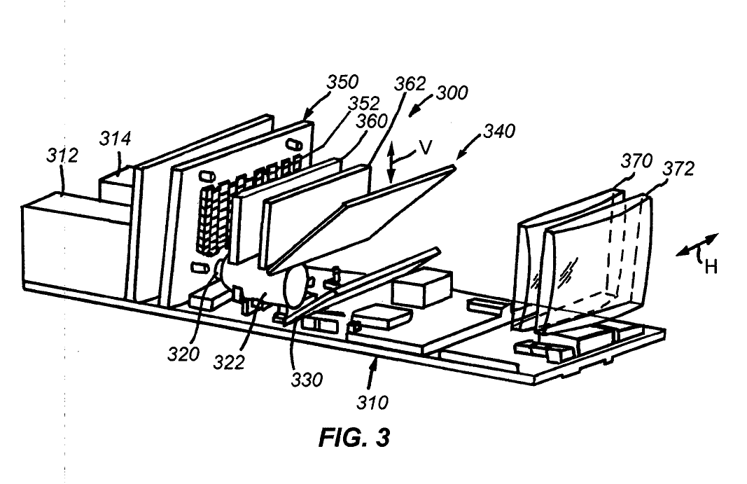

FIG. 3 details the internal components of a machine vision device 300 according to an illustrative embodiment of this invention. The device 300 consists of a main circuit board 310 that includes various power supply, image processing, networking and data storage hardware and software that can be implemented in accordance with conventional techniques. The board includes a power connection 312 and network interface 314. The network interface allows data transmission between the device and a computer or other data processing apparatus when desired. In this manner, identified wafers can be logged in a remote storage and processing device as appropriate. In addition, various device parameters can be programmed via the interface 314, which can interconnect with a computer running software that allows adjustment of device parameters. These parameters may include illumination control, imager settings (e.g. shutter speed, contrast, etc.), focus, and other wafer-identification-specific functions. The parameters can be adjusted using, for example, a conventional graphical user interface.

The board 310 is interconnected to an imager 320 and associated imager lens 322. In this example, the imager 320 comprises a monochrome charge coupled device (CCD) having a pixel array of conventional size (1024×768 in this example) and an electronic shutter speed of between approximately 60 microseconds and 30 milliseconds. A variety of commercially available imagers based upon various systems (CMOS for example) can be used in various examples of the device 300 so long as they include desired sensitivity to IR in the selected band of operation. These images should have the capability of resolving contrast levels in the IR band as described generally herein. In general, an image with a sensitivity between wavelengths of 800 and 900 nanometers can be employed. The imager lens 322 is in optical communication with a mirror 330 that is oriented at a 45-degree angle as described further below. Above the mirror resides a beam splitter 340, also described further below. Illumination of areas of interest is provided by an illumination assembly 350 that includes an array of individual light emitting diodes (LEDs) that operate in the infrared region of the spectrum. In this example, the LEDs emit light at a wavelength of approximately 880 nanometers. This wavelength can be varied. Between the array 352 and the beam splitter 340 are positioned two commercially available lenticular arrays 360 and 362. The arrays define a large number of individual semicircular lenses that extend vertically (see double arrow V) to provide a horizontal spread (see double arrow H) to the illumination lines generated by the array. This is described in detail below. In one example, the lenticular arrays are each characterized by a pitch of approximately 140-150 lenses per inch. The arrays should avoid any filtering property in the 800 to 900 nanometer band so as to allow free passage of IR.

At the far end of the device, a pair of spherical lenses 370 and 372 is provided. These lenses are spaced for telecentric operation, and are adapted to focus light from the area of interest on the wafer into the imager lens 322 over a working distance of approximately 80-100 millimeters (however, the specified working distance can be highly varied and appropriate adjustments to system components to achieve a different working distance is expressly contemplated). They also serve to generate the desired illumination effect (bright field or dark field, depending upon the portion of the array 352 that is activated. In one example each spherical lens is 0.20 inch at the center and spaced 0.23 inch from edge to edge (thereby defining a gap of approximately 0.02 inch between the lenses). The lenses are each provided with an 880-nanometer “notch” filter coating that rejects (reflects away) all light above and below the specified wavelength range in the IR band. In this example, reflectance of below 0.1% is achieved at the center of the notch (approximately 880 nanometers), while reflectance within about 100 nanometers above or below the notch is maintained appreciably below approximately 1%. This ensures that ambient visible light does not wash out the imager during image acquisition. In addition, the housing, particularly in the region of the front face 422 is coated with a matte finish that is substantially non-reflective and optically black. Where aluminum or a similar housing metal is employed, the non-reflective coating can be applied using an appropriate anodizing process capable of producing such a highly non-reflective/optically black finish.

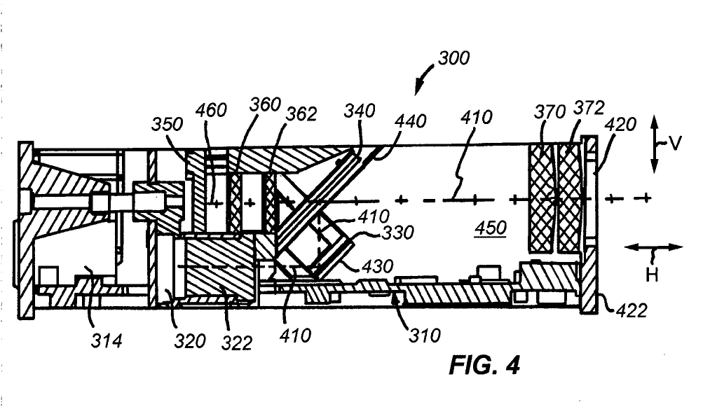

Referring to FIG. 4, the device 300 is shown in cross section. The central axis 410 of the optical path is illustrated. Note that the path extends horizontally (arrow H) from the centroid of the imager 320, through the imager lens 322 to the mirror 330. The mirror deflects the path vertically (arrow V) into the beam splitter 340, where it is again deflected horizontally through the lenses 370, 372 and out the front window 420 in the housing face 422. Note that the mirror 330 and beam splitter 340 by associated edge frames 430 and 440, respectively that can be provided as part of an integral framework attached to the housing walls (450). The beam splitter 340 allows the viewed image to be moved out of line with the illuminator 350. In this manner, light from the illuminator is projected along a direct path 460 to pass through the beam splitter 340 and through the lenses 370, 372. Hence, between the wafer surface and the beam splitter, light and the image share the same approximate path.

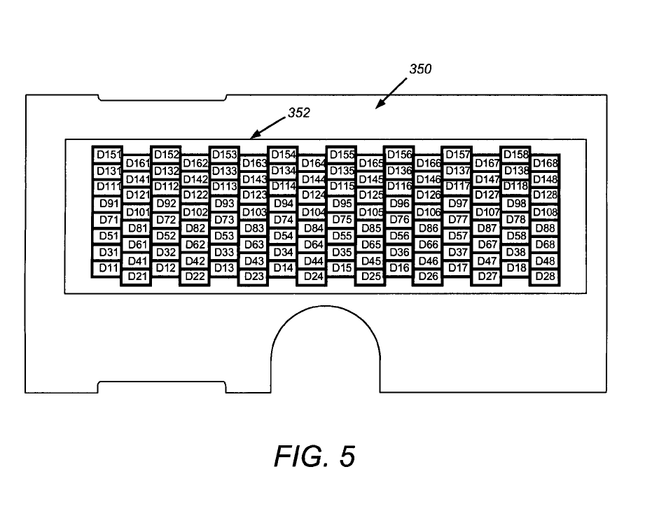

The illumination assembly 350 provides various levels of both direct bright field and dark field illumination over an area of interest, in this example, of approximately 31 millimeters (horizontally) by 19 millimeters (vertically) to ensure adequate illumination. Referring to FIG. 5, the layout of the illumination array 352 according to an embodiment of this invention is shown in further detail. Sixteen rows of surface-mounted, high-output IR LEDs, each row including eight LEDs are provided. The LEDs can have a variety of sizes shapes and characteristics according to various embodiments. In one example, the LEDs are adapted to mount on conventional 0.063-inch spaced solder pads. The LEDs operate in a wavelength of approximately 800-900 nanometers. The LEDs may be operated at their maximum rated voltage or higher due to the short duration of activation. Note that the imager's open shutter time in this embodiment set at approximately 7.5-30 milliseconds (as compared to the typical imager acquisition time using conventional visible red illumination, which may be 2 milliseconds or less). The illumination should remain activated for the full duration of shutter opening.

As shown in FIG. 5, each discrete LED in a row is designated by a reference number Dxy, where x is the row and y is the placement along the row. In this example, x=1 to 16 and y=1 to 8. The rows are staggered so as to provide one LED spacing between each LED in a row. Each row can be individually addressed by the controller using known connectivity techniques. The intervening LED between LEDs in a given row offset by approximately one-half the total LED height to provide the illustrated offset relation between adjacent rows. This allows a pair of partly offset, adjacent rows to be simultaneously illuminated and thereby to generate a bright horizontal line of illumination that appears largely continuous and 1½ LED-widths wide (vertically).

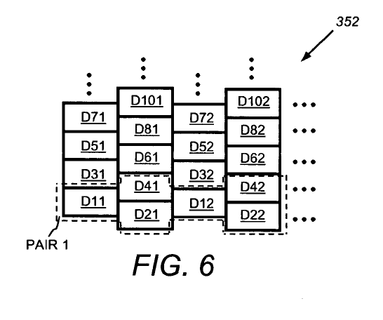

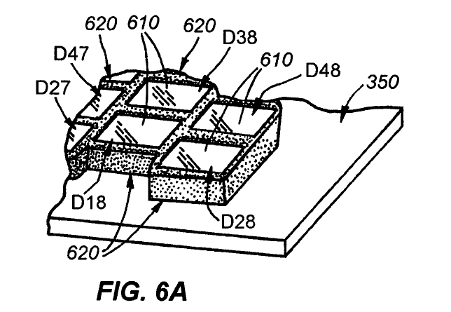

Referring to the close-up fragmentary view of the array 352 in FIG. 6, a pair (PAIR1) is shown. This pair is the bottom-most pair in the array (e.g. row D11-D18 and row D21-D28), and when illuminated, generates a maximum low-angle dark field illumination exiting the front housing window 420. This is because the pair (PAIR1) is offset from the center path (460 in FIG. 4) by a maximum vertical distance. Conversely, a central-most pair of rows (e.g. row D91-D98 and D101-D108) would generate the most direct illumination exiting the normal to the front window 420. As noted above, since the typical symbol would tend to be elongated in the horizontal direction (for example, optical-character-recognition (OCR) characters), the geometry of the lenses and illuminator are biased to provide horizontally enhanced illumination. It is expressly contemplated that, in alternate machine vision applications, a different bias between horizontal and vertical (or a different geometry, such as elliptical or circular) can be employed. Since the array 352 is centered around the central optical path (410), the upper pairs of rows (e.g. rows D151-D158 and D161-168) have approximately the same exit angle from the window 420. If the device's optical axis 410 is oriented perpendicular to the wafer surface, then the bottom pair and the top pair will each generate approximately the same angle of dark field illumination on the surface, but each angle oppositely oriented with respect to the other. If the axis 410 is non-perpendicular with respect to the wafer, then one of the two opposing row pairs will generate a steeper angle of dark field illumination—which may be desirable in certain applications.

Commercially available LEDs typically omit focusing lenses designed to limit the angular field of light. It is common for the light spread to be as much as 120 degrees about the LED's center axis. This wide spread causes some light to migrate out of the side edges of each LED, and into the sides of adjacent LEDs. Thus, if the field is not narrowed, one row of LED may often cause light to be sympathetically transmitted into and out of adjacent rows. FIG. 6A shows simplified perspective view of a group of LEDs D18, D38, D27, D47, D28 and D48 located at one corner of the illumination assembly 350. To avoid excessive migration of light between adjacent LEDs, the side edges of each LED are optically isolated by applying a conformal coating of opaque material 620. In this example, the material is black epoxy, applied with a needle between LEDs so as to fill the small gaps therebetween. In this manner the tops 610 of the LEDs remain exposed, and the angle of transmitted light is significantly reduced. A variety of other techniques for reducing migration of light between rows can be employed in alternate embodiments, such as etched grids that overlay the LEDs, physical barriers between rows, or an array of focusing lenses overlying the LED element. Likewise, while the epoxy surrounds all sides of each LED in this embodiment, in alternate embodiments, the barrier or coating can be applied selectively only between adjacent rows. Note that where individual LEDs exhibit a curved or domed geometry, the epoxy tends to fill the interstices between LEDs to expose only the top portion of each dome, while covering the sides, that direct light sideways.

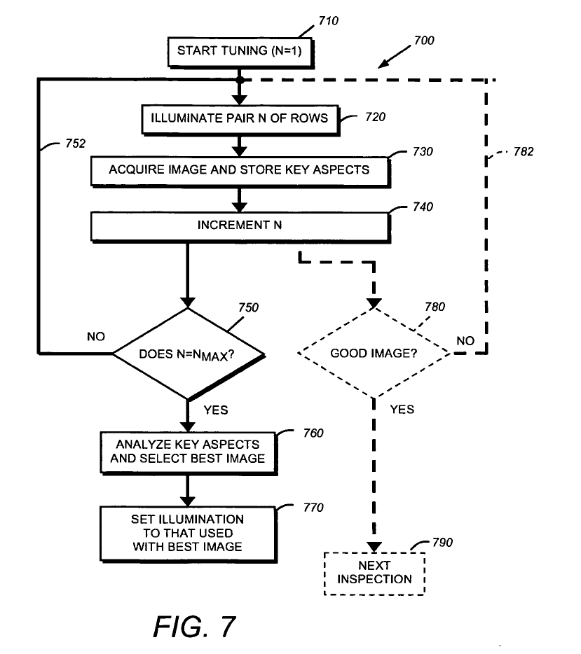

According to the illustrative embodiment, the ability address individual rows and groups of rows within the array allows the illumination to be fine-tuned each time the device 300 is setup at a viewing position, each time the device is powered up, or even for each wafer viewing cycle. In this embodiment, tuning consists of toggling individual pairs of LED rows and determining the result. FIG. 7 details a basic procedure 700 for tuning illumination according to an illustrative embodiment.

In one embodiment, the procedure 700 initiates (step 710) upon an appropriate event such as a user-initiated command, the arrival of a wafer to be viewed or device startup. As described above, the device's control board begins the tuning cycle by addressing the first pair of adjacent LED rows (step 720). The current pair being illuminated is designated as pair N. There are Nmax pairs. These pairs can be each set of adjacent, overlapping rows (hence, Nmax=fifteen pairs). In alternate arrangements additional, non-adjacent, pairings of rows, or other combinations of discrete LEDs can be employed.

Upon the activation of each pair, the imager acquires an image of the surface area of interest. The image is then analyzed and/or stored for later analysis (step 730). The control board then increments its pair count (step 740). If all pairs have not been activated (N≠Nmax), then the procedure branches back (via decision step 750 and branch 752 to step 720, where the next pair of rows are illuminated and the image is acquired and stored (step 730). The procedure continues until each pair has been activated (N=Nmax). The procedure then branches, via decision step 750 to step 760, where the key aspects of the images are viewed and the image that generates the best pattern is selected. The illumination is then set to the pair that generated that best characteristic (step 770).

The above procedure is one approach to setting the best illumination. However, a potentially quicker approach is shown in phantom in FIG. 7. This procedure can be used instead of the above procedure or to provide individual tuning for each wafer being inspected. The procedure begins by illuminating the first pair (steps 710, 720, 730 and 740) and storing readable aspects of the image. The image is then analyzed for readability (decision step 780). In other words, was a good read achieved in which data is retrieved? If so, then no further action is required and the next wafer can be inspected when available (step 790). If the read did not return meaningful data or the system is unsure, then the decision step 78 branches (via branch 782) back to step 720 in which the next pair of rows are illuminated. This need not be the next adjacent pair, but could be an opposing pair on the other end of the array or a central pair. In this manner, an opposing-angle dark field or bright field illumination can follow a given angle of dark field illumination. In this manner it is likely that the device will quickly attain sufficient illumination.

It should be clear that the use of IR illumination alleviates the undesirable effects of refraction that occur when attempting to apply long-wavelength visible light to a surface covered variably with layers of a photoresist (or optically similar) compound. By incorporating such illumination in to a unique and tunable machine vision device as provided above, this invention provides highly effective system and method for reliably reading and decoding symbols on such a surface having both specular regions and non-specular regions that include a layered coating (for example, a semi-opaque compound like silicon nitride).

The foregoing has been a detailed description of an illustrative embodiment of the invention. Various modifications and additions can be made without departing from the spirit and scope thereof. For example, while the machine vision device described includes both illumination and imaging aligned along a single outlet window, it is expressly contemplated that separate ports and axes can be provided for illumination in an alternate embodiment. Likewise while a given number of selectively addressable individual IR sources are provided in this embodiment, in alternate embodiments, IR illumination can be directed to a surface using light pipes, mirrors or other structures that may serve to reduce the number of discrete light sources employed or allow a single light source to be used. Also, while the imager is located along an optical axis that is substantially parallel to the main optical axis of the window and illumination assembly, it is contemplated that the imager axis can be oriented normal to or at an angle to the main axis with appropriate positioning of the mirror and/or the beam splitter to accommodate this placement. In addition, it is expressly contemplated that any of the processes or procedures carried out herein can be implemented as hardware, software, consisting of computer implemented program instructions, or a combination of hardware and software. Accordingly, this description is meant to be taken only by way of example, and not to otherwise limit the scope of this invention.

What is claimed is:

1. A machine vision system mounted to view a surface with specular regions and non-specular regions that include a layered coating comprising:
an imager that acquires images of an area of interest on the surface with the specular regions and the non-specular regions that include the layered coating;
an illumination assembly that projects light in a predetermined range of the infrared IR band of the light spectrum onto the area of interest;
wherein the imager is adapted to sense light in the predetermined range of the IR band so as to differentiate between scribed and unscribed parts of the area of interest; and
a control that decodes symbology represented by the scribed parts.

2. The machine vision system as set forth in claim 1 wherein the symbology comprises at least one of a barcode and an alphanumeric character string.

3. The machine vision system as set forth in claim 2 wherein the area of interest comprises a surface of a silicon wafer covered variably with layers of photoresist.

4. The machine vision system as set forth in claim 3 wherein the photoresist comprises a silicon nitride compound.

5. The machine vision system as set forth in claim 1 wherein the illumination assembly comprises a plurality of discrete IR light sources arranged in rows, each of the rows being positioned so that, when activated, the rows each generate a line of light having one of either a predetermined bright field or predetermined dark field characteristic.

6. The machine vision system as set forth in claim 5 wherein side edges of each of the rows are optically isolated from side edges of adjacent of the rows so that migration of light between rows is reduced.

7. The machine vision system as set forth in claim 6 wherein the side edges of each of the rows that are adjacent to each other includes a conformal coating that blocks light transmission.

8. The machine vision system as set forth in claim 6 further comprising a control that causes at least a pair of adjacent rows to be illuminated simultaneously to generate the line.

9. The machine vision system as set forth in claim 8 wherein the discrete IR light sources in each of the rows are located so as to be offset in part from the discrete light sources of adjacent of the rows.

10. The machine vision system as set forth in claim 9 further comprising a lenticular array assembly located between an outlet window and the illumination assembly.

11. The machine vision system as set forth in claim 10 wherein the discrete light sources comprise IR light emitting diodes.

12. The machine vision system as set forth in claim 6 further comprising a control that is adapted to activate each of the rows according to a predetermined pattern and to acquire and decode images of the surface while each of the rows is activated so as to acquire at least one readable image.

13. The machine vision system as set forth in claim 1 wherein the illumination assembly is located on a first optical axis in line with an outlet window and the imager is located along a second optical axis remote from the first optical axis and further comprising a beam splitter in line with the first optical axis that allows light from the illumination assembly to pass to the outlet window and that directs received light from the surface and through the window into line with the second optical axis.

14. The machine vision system as set forth in claim 13 wherein the second optical axis is substantially parallel to the first optical axis and further comprising a mirror that deflects light from the beam splitter into line with the second optical axis.

15. The machine vision system as set forth in claim 12 wherein the illumination assembly comprises a plurality of discrete IR illumination sources arranged in rows so as to each generate lines of light.

16. The machine vision system as set forth in claim 15 wherein side edges of each of the rows are optically isolated from side edges of adjacent of the rows so that migration of light between rows is reduced.

17. The machine vision system as set forth in claim 16 further comprising a plurality of spherical lenses arranged adjacent to the window in line with the first optical axis.

18. The machine vision system as set forth in claim 17 further comprising a lenticular array assembly located between the beam splitter and the illumination assembly to spread light from the discrete light sources into a substantially continuous line of light.

19. The machine vision system as set forth in claim 17 wherein at least one of the lenses includes a notch filter coating that is adapted to filter out visible light having a wavelength shorter than a characteristic wavelength of IR.

20. A method for reading symbology on a surface with specular regions and non-specular regions that include a layered coating comprising the steps of:
acquiring images of an area of interest on the surface with the specular regions and the non-specular regions that include the layered coating;
projecting light in a predetermined range of the infrared IR band of the light spectrum onto the area of interest during the step of acquiring;
sensing light in the predetermined range of the IR band so as to differentiate between scribed and unscribed parts of the area of interest; and
decoding data represented by the scribed parts.

21. The method as set forth in claim 20 wherein the step of decoding includes deciphering at least one of either barcode data or alphanumeric character data therefrom.

22. The method as set forth in claim 20 wherein the area of interest comprises a surface of a silicon wafer covered variably with layers of photoresist.

23. The method as set forth in claim 20 wherein the step of projecting includes activating each of a plurality of rows of discrete IR light sources, each of the rows being positioned so that, when activated, the rows each generate a line of light having one of either a predetermined bright field or predetermined dark field characteristic.

24. The method as set forth in claim 23 wherein the step of projecting includes optically isolating side edges of adjacent rows so as to reduce migration of light between rows.

25. The method as set forth in claim 24 further comprising illuminating at least a pair of adjacent rows simultaneously to generate the line.

26. The method as set forth in claim 25 further comprising activating each of the rows according to a predetermined pattern and acquiring and decoding images of the surface while each of the rows is activated so as to acquire at least one readable image.

27. The method as set forth in claim 26 wherein the step of activating each of the rows includes activating the rows in an order that causes non-adjacent rows to be activated in-turn.

28. The method as set forth in claim 20 wherein the step of projecting includes projecting the light along a first optical axis in line with an outlet window and the step of acquiring includes receiving light from the surface in line with a second optical axis remote from the first optical axis.

29. The method as set forth in claim 28 further comprising locating a beam splitter and a mirror to deflect light received from the image from the first optical axis to the second optical axis.
